(19) United States
(12) Patent Application Publication
(10) Pub. No.: US 2025/0320705 A1
(43) Pub. Date: Oct. 16, 2025

(54) AUTOMATIC DRIVING UNIT FOR TOILET DRAIN VALVE AND DRAIN VALVE ASSEMBLY

(71) Applicant: ZHONGSHAN DONGLING WEILI CLEAN TECHNOLOGY CO., LTD., Zhongshan, Guangdong (CN)

(72) Inventors: Yuxin Ou, Zhongshan, Guangdong (CN); Wenzhong Chen, Zhongshan, Guangdong (CN); Kehuan Hu, Zhongshan, Guangdong (CN); Huaping Li, Zhongshan, Guangdong (CN); Jinshui Chen, Zhongshan, Guangdong (CN)

(21) Appl. No.: 18/866,104

(22) PCT Filed: May 30, 2023
(86) PCT No.: PCT/CN2023/097252

§ 371 Date: Nov. 15, 2024

(30) Foreign Application Priority Data
Aug. 19, 2022 (CN) 202222199796.0

(51) Int. Cl. E03D 5/10; E03D 1/34; E03D 5/02

(52) U.S. Cl. CPC E03D 5/10; E03D 1/34; E03D 5/022

(57) ABSTRACT

The present disclosure provides an automatic driving unit for a toilet drain valve and a drain valve assembly. The automatic driving unit includes a driving component, and an execution component provided in a valve casing; the execution component includes a fixed member and a movable member provided on the fixed member; and the fixed member is fixed in the valve casing, and located between a valve trim and a slider. The automatic driving unit can be directly integrated onto the drain valve of the toilet, thus directly driving the valve trim of the drain valve. While keeping functions of the original drain valve, the automatic driving unit with such a structure for the drain valve automatically drives the valve trim and can be used conveniently. The automatic driving unit makes the toilet used more conveniently, and further has a desirable stability in use and a low maintenance cost.

### TECHNICAL FIELD

The present disclosure relates to the technical field of toilets, and in particular to an automatic driving unit for a toilet drain valve and a drain valve assembly.

### BACKGROUND

Toilet is a common utensil in people's life. With development of science and technology, there are more and more types of toilets. Particularly, a smart toilet has received increasingly more attention. The smart toilet is mainly intended to realize automatic drainage of a water tank. As a main drainage structure of the toilet, a drain valve in the smart toilet is electrically controlled in the prior art. Specifically, an electromagnetic valve, a controller and other control components are provided at each of a water inlet and a water outlet of the water tank. A corresponding control program is provided in the controller. The controller controls a state of the electromagnetic valve to realize automatic flushing of the toilet. However, the drainage system of the smart toilet is mainly realized through mutual cooperation among a plurality of electrically controlled components. This causes a complex structure and a high cost. In addition, since the drain valve is provided in the water tank, the electrically controlled components have a high failure rate if soaked in water for a long time, and are usually replaced in maintenance.

Therefore, the toilet drainage structure in the prior art has problems of a poor stability and a high maintenance cost.

### SUMMARY

An objective of the present disclosure is to solve problems of a poor stability and a high maintenance cost of a toilet drainage structure in the prior art.

To solve the above technical problems, an implementation of the present disclosure provides an automatic driving unit for a toilet drain valve, where the drain valve is provided in a water tank of a toilet, and includes a valve casing, a valve trim, and a slider; the valve casing is provided with a water inlet located on a sidewall and communicating with the water tank, and a drain outlet located at one end; the valve trim is provided in the valve casing, and abuts against the drain outlet in an openable sealing manner; and the slider is provided at the other end of the valve casing and is in transmission connection with the valve trim;
further, the automatic driving unit includes a driving component, and an execution component provided in the valve casing;
the execution component includes a fixed member and a movable member provided on the fixed member; the fixed member is fixed in the valve casing, and located between the valve trim and the slider; the movable member is movably provided on the fixed member along an axial direction of the valve casing relative to the fixed member; and the movable member is in transmission connection with the valve trim;
the driving component is provided outside the valve casing, is in transmission connection with the movable member and is configured to drive the movable member to move relative to the fixed member; and
the driving component is electrically connected to a sensing component on the toilet; and the sensing component is configured to acquire body information of a user, convert the body information into an electrical signal and transmit the electrical signal to the driving component.

With the above technical solution provided by the implementation, the automatic driving unit can be directly integrated onto the drain valve of the toilet, thus directly driving the valve trim of the drain valve. While keeping functions of the original drain valve, the automatic driving unit with such a structure for the drain valve automatically drives the valve trim. This does not need manual operation and is convenient in use.

In addition, the execution component of the automatic driving unit is provided in the valve casing, and located on the valve trim. This can make the drain valve drain water automatically at a larger footprint. On the other hand, there is a short transmission distance between the execution component and the valve trim to achieve a high transmission efficiency.

In addition, when installed on the drain valve, the automatic driving unit is directly provided between the slider and the valve trim, without changing other structures of the drain valve. After long-time use, even in case of a fault of a component, only the corresponding component is repaired or replaced without affecting other components. The drain valve keeps the original functions. Even in case of a fault of the automatic driving unit, the toilet also drains water normally.

Therefore, when applied to the toilet, the automatic driving unit provided by the implementation makes the toilet used more conveniently, and has a good stability in use and a low maintenance cost.

According to the automatic driving unit for a toilet drain valve provided by another implementation of the present disclosure,
the fixed member is provided with a housing; and the housing is nested in the valve casing and fixed on an inner wall of the valve casing; and
the movable member is a piston nested in the housing; and an end of the piston extends out of an end of the housing close to the valve trim and is fixedly connected to an end of the valve trim; or
the movable member is a piston nested in the housing; and an end of the piston extends out of an end of the housing away from the valve trim and is fixedly connected to an inner end of the slider.

In a solution provided by the implementation, the movable member directly drives the valve trim to move, such that the drain valve is open or closed with a short transmission path. The automatic driving unit on the drain valve improves a transmission efficiency between the automatic driving unit and the valve trim of the drain valve.

In another solution provided by the implementation, the movable member drives the slider, such that the valve trim is open or closed with an original transmission manner between the slider and the valve trim. This can realize automatic driving without changing an original transmission principle of the drain valve. Not only a simple structure, but also a simpler transmission principle, is achieved.

According to the automatic driving unit for a toilet drain valve provided by another implementation of the present disclosure, the driving component includes a pressure adjustment component; the housing is a sealed housing and forms a sealed chamber inside; the piston includes a piston body and a piston rod; and the piston body can be slidably connected in the sealed chamber; and
when the end of the piston extends out of the end of the housing close to the valve trim and is fixedly connected to the end of the valve trim, a through hole is formed at the end of the housing close to the valve trim; the piston rod includes one end fixedly connected to the piston body, and the other end fixedly connected to the valve trim via the through hole; an outer wall of the piston rod is hermetically connected with an inner wall of the through hole; and the pressure adjustment component communicates with the sealed chamber through a pressure pipeline penetrating through the valve casing and a sidewall of the housing; or
when the end of the piston extends out of the end of the housing away from the valve trim and is fixedly connected to the inner end of the slider, a through hole is formed at an end of the housing close to the slider; the piston rod includes one end fixedly connected to the piston body, and the other end fixedly connected to the inner end of the slider via the through hole; an outer wall of the piston rod is in the sealing connection with an inner wall of the through hole; and the pressure adjustment component communicates with the sealed chamber through a pressure pipeline penetrating through the valve casing and a sidewall of the housing.

With the technical solution provided by the implementation, the housing is the sealed housing. When the housing is provided in the valve casing, since the housing is a sealed structure, a water pressure in the valve casing does not cause interference to normal work of the execution component.

In addition, the driving component uses the pressure adjustment component. Because of easy arrangement of pressure transmission, the automatic driving unit can be integrated onto the drain valve of the toilet more conveniently.

According to the automatic driving unit for a toilet drain valve provided by another implementation of the present disclosure, the pressure adjustment component includes a hydraulic pump or an air pump.

According to the automatic driving unit for a toilet drain valve provided by another implementation of the present disclosure, the fixed member further includes an electromagnetic member provided in the housing; the movable member is a magnetic sensing member opposite to the electromagnetic member; and the driving component is a power supply; and
when the end of the piston extends out of the end of the housing close to the valve trim and is fixedly connected to the end of the valve trim, one of the electromagnetic member and the magnetic sensing member is fixedly connected in the housing, while the other one is movably provided in the housing, located between the electromagnetic member and the valve trim, and fixedly connected to the valve trim; or
when the end of the piston extends out of the end of the housing away from the valve trim and is fixedly connected to the inner end of the slider, one of the electromagnetic member and the magnetic sensing member is fixedly connected in the housing, while the other one is movably provided in the housing, located between the electromagnetic member and the slider, and fixedly connected to the slider.

With the above technical solution, a repulsive force between the electromagnetic member and the magnetic sensing member is used to realize movement of the movable member. An individual driver turns out to be unnecessary and a simpler structure is achieved. This further simplifies a structure of the drain valve using the automatic driving unit, and has a lower installation cost.

According to the automatic driving unit for a toilet drain valve provided by another implementation of the present disclosure, the housing is a sealed housing, and both the electromagnetic member and the magnetic sensing member are provided in the housing.

With the above technical solution, since the housing is the sealed housing, the electromagnetic member and the magnetic sensing member can be separated from the water in the valve casing. When the electromagnetic member and the magnetic sensing member are repulsive to each other to drive the valve trim to move, the water pressure in the valve casing does not affect a repulsive force between the electromagnetic member and the magnetic sensing member. Therefore, the solution provided by the implementation can further improve a working stability of the drain valve.

According to the automatic driving unit for a toilet drain valve provided by another implementation of the present disclosure, the electromagnetic member is an electromagnet, and the magnetic sensing member is a permanent magnet or a metal member.

According to the automatic driving unit for a toilet drain valve provided by another implementation of the present disclosure, the fixed member further includes a gear provided in the housing; the movable member is a rack engaged with the gear and extending along the axial direction of the valve casing; the driving component is a motor; a guide seat is further provided on the inner wall of the valve casing; the rack is slidably connected to the guide seat; and the gear is fixedly connected to an output shaft of the motor; and
when the end of the piston extends out of the end of the housing close to the valve trim and is fixedly connected to the end of the valve trim, an end of the rack is fixedly connected to the valve trim; or
when the end of the piston extends out of the end of the housing away from the valve trim and is fixedly connected to the inner end of the slider, an end of the rack is fixedly connected to the slider.

With the above technical solution provided by the implementation, transmission between the gear and the rack is used. The gear and the rack are not affected by an external pressure in either case, and have more stable performance when installed in the valve casing. On the other hand, the gear and the rack have a high transmission accuracy. When a transmission structure for the gear and the rack is used to drive the valve trim to move, the valve trim has a more accurate displacement, thereby accurately controlling a water draining amount of the toilet to save a water resource.

According to the automatic driving unit for a toilet drain valve provided by another implementation of the present disclosure, the sensing component includes a capacitive sensor or a pressure sensor provided in a seat ring of a toilet seat, and the sensing component is configured to detect body information of the seat ring and generate a sensing signal.

With the above technical solution provided by the implementation, the sensing component is the capacitive sensor or the pressure sensor integrated onto the seat ring of the toilet. The capacitive sensor or the pressure sensor can directly detect the body characteristic information, and generate the sensing signal through an own structure. Other signal conversion elements turn out to be unnecessary, and a simpler structure is achieved.

According to the automatic driving unit for a toilet drain valve provided by another implementation of the present disclosure, the automatic driving unit for a toilet drain valve further includes an operating button; and the operating button is fixed on an outer wall of the toilet seat, and electrically connected to the driving component.

Through the operating button, the driving component drives the execution component.

With the above technical solution provided by the implementation, the button is provided on the outer wall of the toilet seat. The user can further actively control the automatic driving unit through the operating button in use, and thus a desirable stability is achieved.

According to the automatic driving unit for a toilet drain valve provided by another implementation of the present disclosure, the operating button includes a base as well as a switch and a timing member that are arranged on the base; the switch is provided with an operating key outside the base; and the switch and the timing member are electrically connected to each other.

When the operating key is pressed, the timing member starts timing, and the driving component drives the execution component. When time of the timing member reaches to a preset time threshold, the driving component drives the execution component to recover to an initial state.

With the above technical solution provided by the implementation, by integrating the timing member to the operating button, the automatic driving unit drives the valve trim to open for a period of time and then automatically closes the valve trim. This achieves a higher degree of automation, and a more reasonable water draining amount in toilet flushing, without wasting water in the toilet flushing.

Another implementation of the present disclosure provides a drain valve assembly of a toilet, including a drain valve and the automatic driving unit with the above structure, where at least the execution component in the automatic driving unit is provided in the valve casing of the drain valve.

With the above technical solution, by integrating the automatic driving unit onto the toilet, while functions of the original drain valve can be kept, the valve trim is driven automatically. This does not need manual operation and is convenient in use. Particularly, when installed on the drain valve, the automatic driving unit is directly provided between the slider and the valve trim, without changing other structures of the drain valve. After long-time use, even in case of a fault of a component, only the corresponding component is repaired or replaced without affecting other components. The drain valve keeps the original functions. Even in case of a fault of the automatic driving unit, the toilet also drains water normally. Therefore, when applied to the toilet, the automatic driving unit with such a structure provided by the implementation makes the toilet used more conveniently, and has a good stability in use and a low maintenance cost.

The present disclosure has the following beneficial effects:

According to the automatic driving unit for a toilet drain valve, the automatic driving unit can be directly integrated onto the drain valve of the toilet, thus directly driving the valve trim of the drain valve. While keeping functions of the original drain valve, the automatic driving unit with such a structure for the drain valve automatically drives the valve trim. This does not need manual operation and is convenient in use.

The automatic driving unit further includes a driving component, and an execution component provided in the valve casing. The execution component includes a fixed member and a movable member provided on the fixed member. The fixed member is fixed in the valve casing, and located between the valve trim and the slider. This can make the drain valve drain water automatically at a larger footprint. On the other hand, there is a short transmission distance between the execution component and the valve trim to achieve a high transmission efficiency.

Further, when installed on the drain valve, the automatic driving unit is directly provided between the slider and the valve trim, without changing other structures of the drain valve. After long-time use, even in case of a fault of a component, only the corresponding component is repaired or replaced without affecting other components. The drain valve keeps the original functions. Even in case of a fault of the automatic driving unit, the toilet also drains water normally.

Therefore, when applied to the drain valve of the toilet, the automatic driving unit provided by the implementation makes the toilet used more conveniently, and has a good stability in use and a low maintenance cost.

### BRIEF DESCRIPTION OF THE DRAWINGS

FIG. 1a is a schematic structural view illustrating an open state of a valve trim in an automatic driving unit for a toilet drain valve according to Embodiment 1 of the present disclosure, a driving component being a pressure adjustment component;

FIG. 1b is a schematic structural view illustrating a closed state of a valve trim in an automatic driving unit for a toilet drain valve according to Embodiment 1 of the present disclosure, a driving component being a pressure adjustment component;

FIG. 2a is a schematic structural view illustrating an open state of a valve trim in another automatic driving unit for a toilet drain valve according to Embodiment 1 of the present disclosure, a driving component being a power supply;

FIG. 2b is a schematic structural view illustrating a closed state of a valve trim in another automatic driving unit for a toilet drain valve according to Embodiment 1 of the present disclosure, a driving component being a power supply;

FIG. 3a is a schematic structural view illustrating an open state of a valve trim in still another automatic driving unit for a toilet drain valve according to Embodiment 1 of the present disclosure, a driving component being a motor;

FIG. 3b is a schematic structural view illustrating a closed state of a valve trim in still another automatic driving unit for a toilet drain valve according to Embodiment 1 of the present disclosure, a driving component being a motor;

FIG. 4a is a schematic structural view illustrating an open state of a valve trim in an automatic driving unit for a toilet drain valve according to Embodiment 2 of the present disclosure, a driving component being a pressure adjustment component;

FIG. 4b is a schematic structural view illustrating a closed state of a valve trim in an automatic driving unit for a toilet drain valve according to Embodiment 2 of the present disclosure, a driving component being a pressure adjustment component;

FIG. 5a is a schematic structural view illustrating an open state of a valve trim in another automatic driving unit for a toilet drain valve according to Embodiment 2 of the present disclosure, a driving component being a power supply;

FIG. 5b is a schematic structural view illustrating a closed state of a valve trim in another automatic driving unit for a toilet drain valve according to Embodiment 2 of the present disclosure, a driving component being a power supply;

FIG. 6a is a schematic structural view illustrating an open state of a valve trim in still another automatic driving unit for a toilet drain valve according to Embodiment 2 of the present disclosure, a driving component being a motor; and

FIG. 6b is a schematic structural view illustrating a closed state of a valve trim in still another automatic driving unit for a toilet drain valve according to Embodiment 2 of the present disclosure, a driving component being a motor.

### REFERENCE NUMERALS

100: drain valve;
110: valve casing, 111: drain outlet, 120: valve trim, and 130: slider;
200: automatic driving unit;
211: pressure adjustment component, 212: housing, 213: piston rod, 214: piston body, 215: first connecting hole, and 216: second connecting hole;
221: electromagnetic member, 222: magnetic sensing member, and 223: power supply; and
231: gear, 232: rack, and 233: motor.

### DETAILED DESCRIPTION

The implementations of the present disclosure are described below through specific embodiments, and those skilled in the art can easily understand other advantages and effects of the present disclosure from the contents disclosed in this specification. Although the present disclosure is described in conjunction with preferred embodiments, features of the present disclosure are not only limited to the implementations. Conversely, descriptions of the present disclosure in conjunction with the implementations are intended to cover other possible extended selections or modifications based on claims of the present disclosure. For the sake of deep understanding on the present disclosure, many particular details are included in the following descriptions. The present disclosure may also not be implemented with these details. In addition, in order not to make emphasis of the present disclosure confused or obscure, some particular details are omitted in the following descriptions. It should be noted that embodiments in the present disclosure or features in the embodiments may be combined with one another without conflict.

It should be noted that similar reference signs and letters represent similar items in the accompanying drawings below. Therefore, once an item is defined in one accompanying drawing, it does not need to be further defined and described in subsequent accompanying drawings.

In the description of the present disclosure, it should be noted that orientations or position relationships indicated by terms such as “upper”, “lower”, “inner” and “bottom” are orientation or position relationships shown in the accompanying drawings, and these terms are only used to facilitate description of the present disclosure and simplify the description, but not to indicate or imply that the mentioned apparatus or components must have a specific orientation or must be established and operated in a specific orientation, and thus these terms cannot be understood as a limitation to the present disclosure.

In addition, the terms such as “first” and “second” are used only for distinguishing description and cannot be understood as indicating or implying relative importance.

In the description of the present disclosure, it should be noted that, unless otherwise clearly specified, meanings of terms “mount”, “connect with”, and “connect to” should be understood in a broad sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand specific meanings of the foregoing terms in the embodiments of the present disclosure based on a specific situation.

In order to make the objectives, technical solutions, and advantages of the present disclosure clearer, the implementations of the present disclosure will be further described in detail with reference to the accompanying drawings.

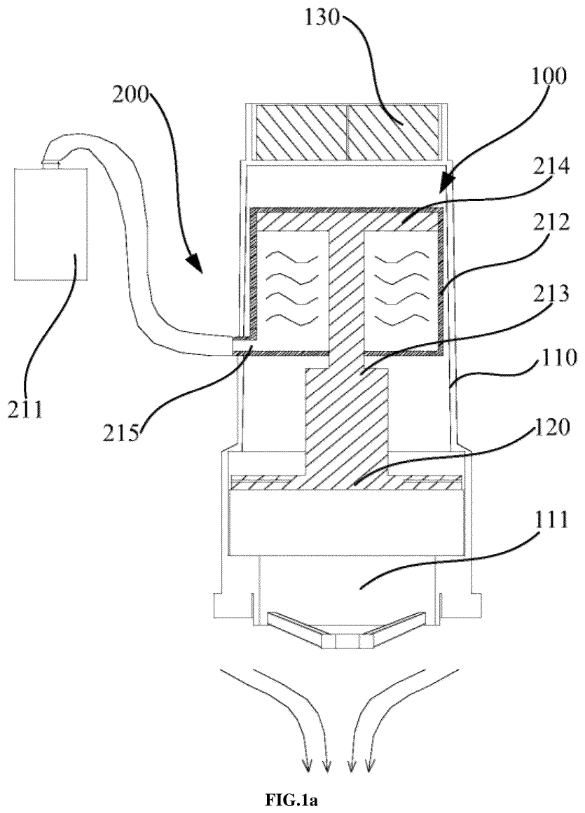

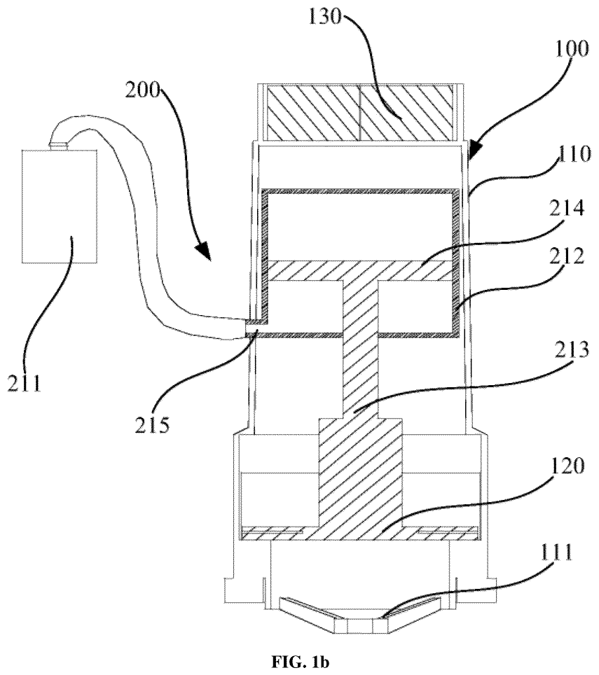

As shown in FIG. 1a to FIG. 6b, a drain valve is provided in a water tank of a toilet, and specifically includes a valve casing 110, a valve trim 120, and a slider 130. The valve casing 110 is provided with a water inlet located on a sidewall and communicating with the water tank, and a drain outlet 111 located at one end. The valve trim 120 is provided in the valve casing 110, and abuts against the drain outlet 111 in an openable sealing manner. The slider 130 is provided at the other end of the valve casing 110 and is in transmission connection with the valve trim 120.

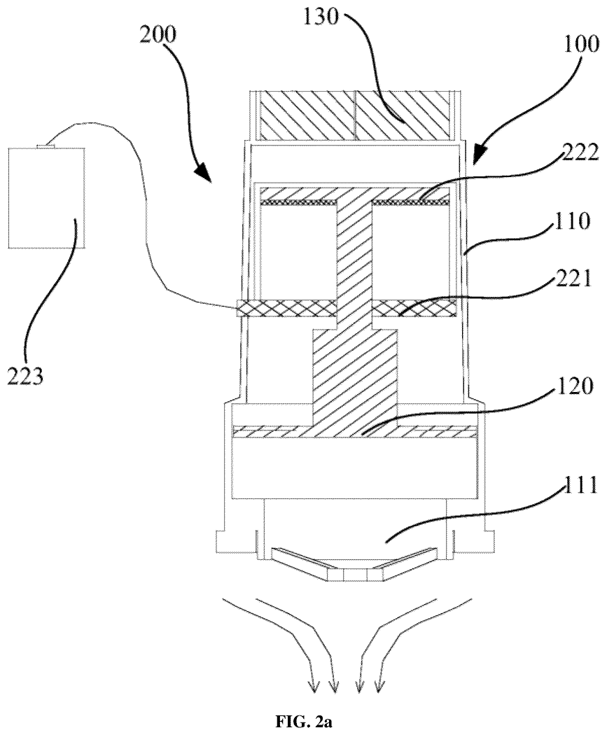

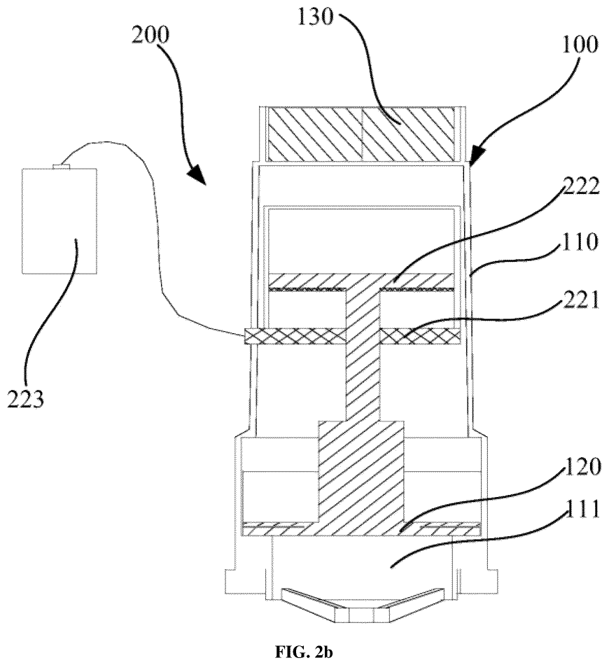

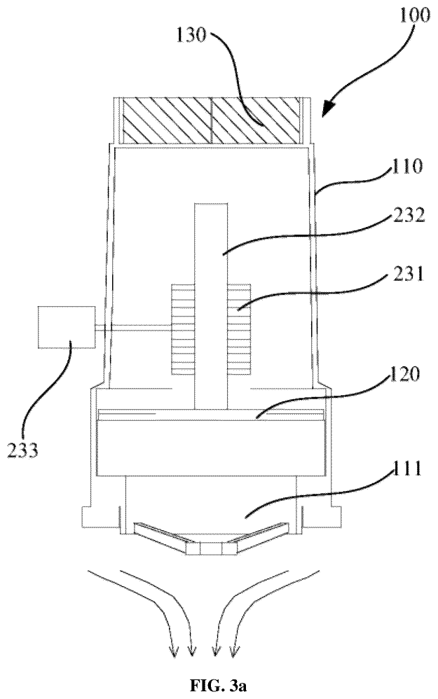

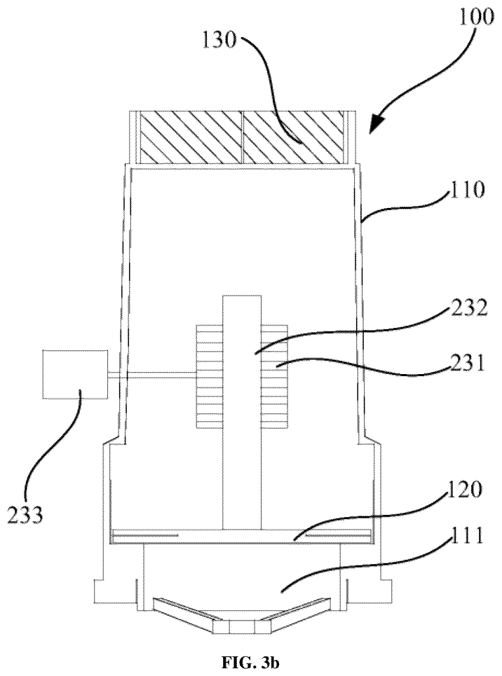

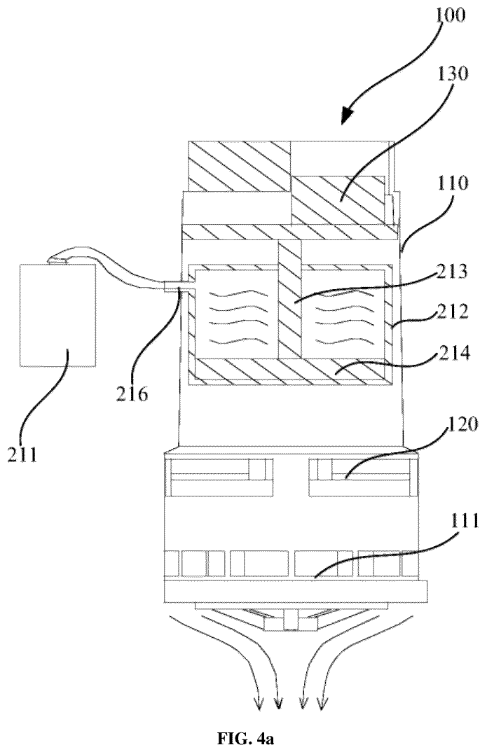

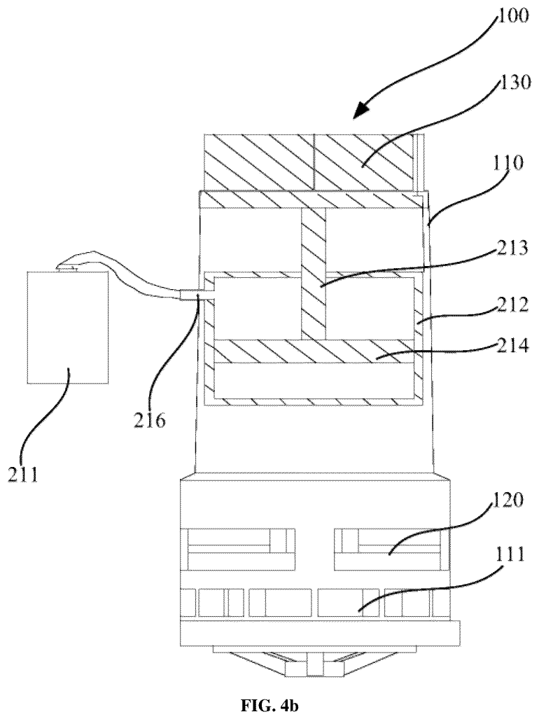

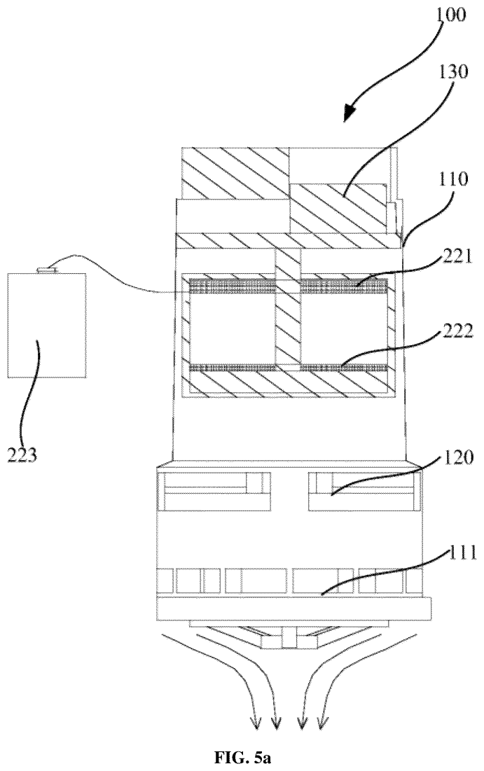

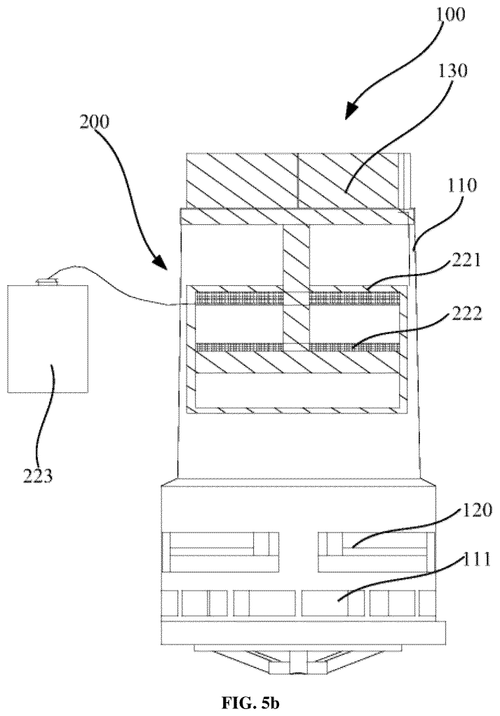

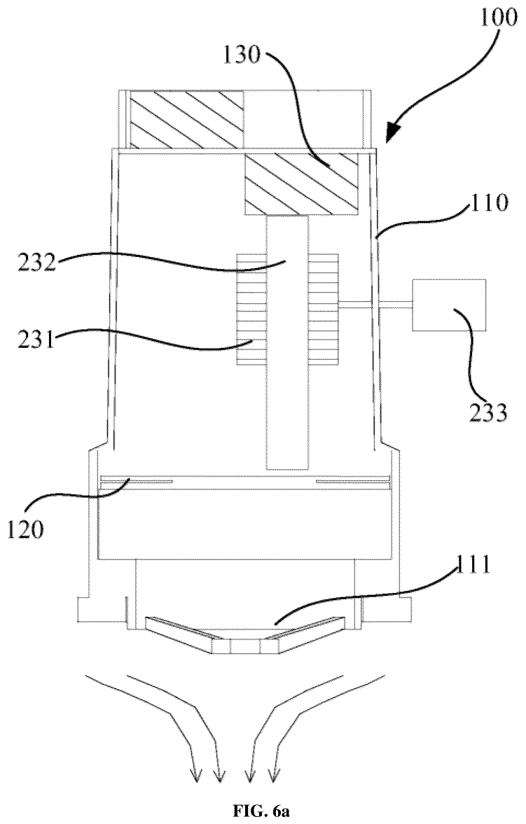

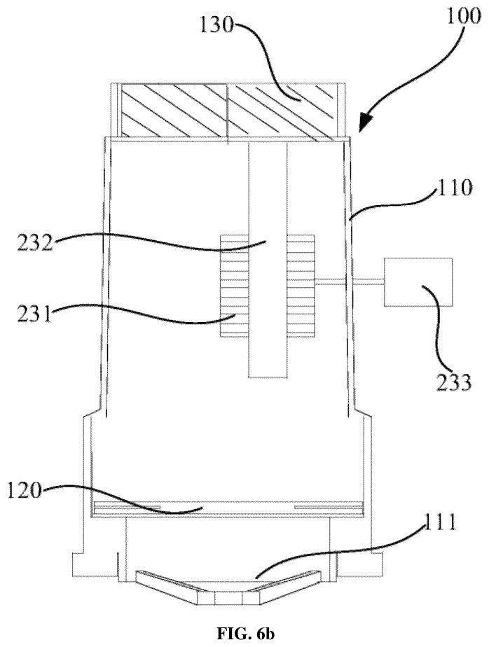

The automatic driving unit 200 for a toilet drain valve provided by the embodiment of the present disclosure can be directly integrated onto the drain valve 100, thus directly driving the valve trim 120 to open or close the drain valve 100. Specifically, FIG. 1a, FIG. 2a, FIG. 3a, FIG. 4a, FIG. 5a and FIG. 6a show an open state of the drain valve 100. FIG. 1b, FIG. 2b, FIG. 3b, FIG. 4b, FIG. 5b and FIG. 6b show a closed state of the drain valve 100.

Specifically, the automatic driving unit 200 further includes a driving component, and an execution component provided in the valve casing 110. The execution component includes a fixed member and a movable member provided on the fixed member. The fixed member is fixed in the valve casing 110, and located between the valve trim 120 and the slider 130. The movable member is movably provided on the fixed member along an axial direction of the valve casing 110 relative to the fixed member. The movable member is in transmission connection with the valve trim 120. The driving component is provided outside the valve casing 110, is in transmission connection with the movable member and is configured to drive the movable member to move relative to the fixed member.

Specifically, in the embodiment, the movable member is slidably connected to the fixed member.

Further, the driving component is electrically connected to a sensing component on the toilet. The sensing component is configured to acquire body information of a user, convert the body information into an electrical signal and transmit the electrical signal to the driving component.

The automatic driving unit 200 provided by the embodiment can be directly integrated onto the drain valve 100 of the toilet, thus directly driving the valve trim 120 of the drain valve 100. While keeping functions of the original drain valve 100, the automatic driving unit 200 with such a structure for the drain valve 100 automatically drives the valve trim 120. This does not need manual operation and is convenient in use.

Further, the execution component of the automatic driving unit 200 is provided in the valve casing 110, and located on the valve trim 120. This can make the drain valve 100 drain water automatically at a larger footprint. On the other hand, there is a short transmission distance between the execution component and the valve trim 120 to achieve a high transmission efficiency.

Still further, when installed on the drain valve 100, the automatic driving unit 200 is directly provided between the slider 130 and the valve trim 120, without changing other structures of the drain valve 100. After long-time use, even in case of a fault of a component, only the corresponding component is repaired or replaced without affecting other components. The drain valve 100 further keeps the original functions. Even in case of a fault of the automatic driving unit 200, the toilet also drains water normally.

Therefore, when applied to the toilet, the automatic driving unit 200 provided by the embodiment makes the toilet used more conveniently, and has a good stability in use and a low maintenance cost.

Specific implementations of the automatic driving unit 200 are described below exemplarily:

### Embodiment 1

As shown in FIG. 1a to FIG. 3b, the fixed member is provided with a housing 212. The housing 212 is nested in the valve casing 110 and fixed on an inner wall of the valve casing 110. The movable member is a piston nested in the housing 212. An end of the piston extends out of an end of the housing 212 close to the valve trim 120 and is fixedly connected to an end of the valve trim 120.

In an implementation solution of the embodiment, as shown in FIG. 1a to FIG. 1b, the driving component includes a pressure adjustment component 211. The housing 212 is a sealed housing and forms a sealed chamber inside. The piston includes a piston body 214 and a piston rod 213. The piston body 214 can be slidably connected in the sealed chamber. A through hole is formed at the end of the housing 212 close to the valve trim 120. The piston rod 213 includes one end fixedly connected to the piston body 214, and the other end fixedly connected to the valve trim 120 via the through hole. An outer wall of the piston rod 213 is hermetically connected with an inner wall of the through hole. The pressure adjustment component 211 communicates with the sealed chamber through a pressure pipeline penetrating through the valve casing 110 and a sidewall of the housing 212.

In the solution, the pressure adjustment component 211 is a hydraulic pump or an air pump.

Specifically, the movable member directly drives the valve trim 120 to move, such that the drain valve 100 is open or closed with a short transmission path. The automatic driving unit 200 on the drain valve 100 improves a transmission efficiency between the automatic driving unit 200 and the valve trim 120 of the drain valve 100.

More specifically, a side of the housing 212 close to the valve trim 120 serves as a positive pressure chamber. A first connecting hole 215 is formed at a side of the sidewall of the housing 212 close to the valve trim 120. The positive pressure chamber in the housing 212 communicates with the hydraulic pump or the air pump through the first connecting hole 215 and the pressure pipeline.

In another implementation solution of the embodiment, as shown in FIG. 2a to FIG. 2b, the fixed member includes an electromagnetic member 221 provided in the housing 212. The movable member is a magnetic sensing member 222 opposite to the electromagnetic member 221. The driving component is a power supply 223. One of the electromagnetic member 221 and the magnetic sensing member 222 is fixedly connected in the housing 212, while the other one is movably provided in the housing 212, located between the electromagnetic member 221 and the valve trim 120, and fixedly connected to the valve trim 120.

In the solution, a repulsive force between the electromagnetic member 221 and the magnetic sensing member 222 is used to realize movement of the movable member. An individual driver turns out to be unnecessary and a simpler structure is achieved. This further simplifies a structure of the drain valve 100 using the automatic driving unit 200, and has a lower installation cost.

Preferably, in the solution, the electromagnetic member 221 is an electromagnet, and the magnetic sensing member 222 is a permanent magnet or a metal member. The electromagnetic member 221 is fixedly connected in the housing 212. The magnetic sensing member 222 is movably provided in the housing 212. The magnetic sensing member 222 is located between the electromagnetic member 221 and the valve trim 120, and fixedly connected to the valve trim 120.

Specifically, in the embodiment, the electromagnetic member 221 is fixedly connected to an inner sidewall of the housing 212 close to the valve trim 120. The magnetic sensing member 222 is movably provided in the housing 212 and at a side of the electromagnetic member 221 away from the valve trim 120.

In another implementation solution of the embodiment, as shown in FIG. 3a to FIG. 3b, the fixed member further includes a gear 231 provided in the housing 212. The movable member is a rack 232 engaged with the gear 231 and extending along the axial direction of the valve casing 110. The driving component is a motor 233. A guide seat is further provided on the inner wall of the valve casing 110. The rack 232 is slidably connected to the guide seat. The gear 231 is fixedly connected to an output shaft of the motor 233. An end of the rack 232 is fixedly connected to the valve trim 120.

In the solution, transmission between the gear 231 and the rack 232 is used. The gear 231 and the rack 232 are not affected by an external pressure in either case, and have more stable performance when installed in the valve casing 110. On the other hand, the gear 231 and the rack 232 have a high transmission accuracy. When a transmission structure for the gear 231 and the rack 232 is used to drive the valve trim 120 to move, the valve trim 120 has a more accurate displacement, thereby accurately controlling a water draining amount of the toilet to save a water resource.

### Embodiment 2

As shown in FIG. 4a to FIG. 6b, the fixed member is provided with a housing 212. The housing 212 is nested in the valve casing 110 and fixed on an inner wall of the valve casing 110. The movable member is a piston nested in the housing 212. An end of the piston extends out of an end of the housing 212 away from the valve trim 120 and is fixedly connected to an inner end of the slider 130.

In the embodiment, the movable member drives the slider 130, such that the valve trim 120 is open or closed with an original transmission manner between the slider 130 and the valve trim 120. This can realize automatic driving without changing an original transmission principle of the drain valve 100. Not only a simple structure, but also a simpler transmission principle, is achieved.

Specifically, in an implementation solution of the embodiment, as shown in FIG. 4a to FIG. 4b, the driving component includes a pressure adjustment component 211. The housing 212 is a sealed housing and forms a sealed chamber inside. The piston includes a piston body 214 and a piston rod 213. The piston body 214 can be slidably connected in the sealed chamber. A through hole is formed at an end of the housing 212 close to the slider 130. The piston rod 213 includes one end fixedly connected to the piston body 214, and the other end fixedly connected to an inner end of the slider 130 via the through hole. An outer wall of the piston rod 213 is hermetically connected with an inner wall of the through hole. The pressure adjustment component 211 communicates with the sealed chamber through a pressure pipeline penetrating through the valve casing 110 and a sidewall of the housing 212.

In the solution, the housing 212 is the sealed housing. When the housing 212 is provided in the valve casing 110, since the housing 212 is a sealed structure, a water pressure in the valve casing 110 does not cause interference to normal work of the execution component. The driving component uses the pressure adjustment component 211. Because of easy arrangement of pressure transmission, the automatic driving unit 200 can be integrated onto the drain valve 100 of the toilet more conveniently.

Specifically, in the solution, the pressure adjustment component 211 may be a hydraulic pump or an air pump.

More specifically, a side of the housing 212 close to the valve trim 120 serves as a positive pressure chamber. A second connecting hole 216 is formed at a side of the sidewall of the housing 212 close to the slider 130. The positive pressure chamber in the housing 212 communicates with the hydraulic pump or the air pump through the second connecting hole 216 and the pressure pipeline.

In another implementation solution of the embodiment, as shown in FIG. 5a to FIG. 5b, the fixed member further includes an electromagnetic member 221 provided in the housing 212. The movable member is a magnetic sensing member 222 opposite to the electromagnetic member 221. The driving component is a power supply 223. When the end of the piston extends out of the end of the housing 212 away from the valve trim 120 and is fixedly connected to the inner end of the slider 130, one of the electromagnetic member 221 and the magnetic sensing member 222 is fixedly connected in the housing 212, while the other one is movably provided in the housing 212, located between the electromagnetic member 221 and the slider 130, and fixedly connected to the slider 130.

Likewise, a repulsive force between the electromagnetic member 221 and the magnetic sensing member 222 is used to realize movement of the movable member. An individual driver turns out to be unnecessary and a simpler structure is achieved. This further simplifies a structure of the drain valve 100 using the automatic driving unit 200, and has a lower installation cost.

Specifically, the electromagnetic member 221 serves as an active magnetic control component. In the embodiment, preferably, the electromagnetic member 221 is fixedly connected in the housing 212. The magnetic sensing member 222 is movably provided in the housing 212. The magnetic sensing member 222 is located between the electromagnetic member 221 and the valve trim 120, and fixedly connected to the valve trim 120.

More specifically, specific structures of the electromagnetic member 221 and the magnetic sensing member 222 are the same as those in Embodiment 1, and are not repeated herein.

More specifically, in the embodiment, the electromagnetic member 221 is fixedly connected to an inner sidewall of the housing 212 close to the slider 130. The magnetic sensing member 222 is movably provided in the housing 212 and at a side of the electromagnetic member 221 away from the slider 130.

In another implementation solution of the embodiment, as shown in FIG. 6a to FIG. 6b, the fixed member further includes a gear 231 provided in the housing 212. The movable member is a rack 232 engaged with the gear 231 and extending along the axial direction of the valve casing 110. The driving component is a motor 233. A guide seat is further provided on the inner wall of the valve casing 110. The rack 232 is slidably connected to the guide seat. The gear 231 is fixedly connected to an output shaft of the motor 233. An end of the rack 232 is fixedly connected to the slider 130.

In the embodiment, transmission between the gear 231 and the rack 232 is used. Likewise, this can make the automatic driving unit 200 more stable in the valve casing 110. On the other hand, it can accurately control a water draining amount of the toilet to save a water resource.

Further, on the basis of Embodiment 1 and Embodiment 2, preferably, the housing 212 is a sealed housing, and both the electromagnetic member 221 and the magnetic sensing member 222 are provided in the housing 212.

Specifically, since the housing 212 is the sealed housing, the electromagnetic member 221 and the magnetic sensing member 222 can be separated from the water in the valve casing 110. When the electromagnetic member 221 and the magnetic sensing member 222 are repulsive to each other to drive the valve trim 120 to move, the water pressure in the valve casing 110 does not affect a repulsive force between the electromagnetic member 221 and the magnetic sensing member 222. Therefore, the solution provided by the implementation can further improve a working stability of the drain valve 100.

Still further, in the automatic driving unit 200 for a toilet drain valve provided by the present disclosure, the automatic driving unit 200 further includes an operating button (not shown in the figure). The operating button is fixed on an outer wall of a toilet seat, and electrically connected to the driving component. Through the operating button in use, the driving component drives the execution component. With the structure, the user can further actively control the automatic driving unit 200 through the operating button in use, and thus a desirable stability is achieved.

Specifically, the operating button includes a base as well as a switch and a timing member that are arranged on the base. The switch is provided with an operating key outside the base. The switch and the timing member are electrically connected to each other. When the operating key is pressed, the timing member starts timing, and the driving component drives the execution component. When time of the timing member reaches to a preset time threshold, the driving component drives the execution component to recover to an initial state.

More specifically, by integrating the timing member to the operating button, the automatic driving unit 200 drives the valve trim 120 to open for a period of time and then automatically closes the valve trim. This achieves a higher degree of automation, and a more reasonable water draining amount in toilet flushing, without wasting water in the toilet flushing.

Still further, in the automatic driving unit 200 for a toilet drain valve provided by the present disclosure, the sensing component includes a capacitive sensor or a pressure sensor provided in a seat ring of a toilet seat. The operating button is configured to detect body information of the seat ring and generate a sensing signal.

Specifically, in the embodiment, the sensing component is the capacitive sensor or the pressure sensor integrated onto the seat ring of the toilet. The capacitive sensor or the pressure sensor can directly detect the body characteristic information, and generate the sensing signal through an own structure. Other signal conversion elements turn out to be unnecessary, and a simpler structure is achieved.

In the embodiment, the timing member may be a timer. The time threshold may be 5 s, and may also specifically be another value, which is not solely limited by the embodiment.

Further, another embodiment of the present disclosure further provides a drain valve assembly for a toilet. Specifically, referring to FIG. 1a to FIG. 6b in Embodiment 1 and Embodiment 2, the drain valve assembly includes a drain valve 100 and the automatic driving unit 200 in Embodiment 1 and Embodiment 2. At least the execution component in the automatic driving unit 200 is provided in the valve casing 110 of the drain valve 100.

Specifically, in the embodiment, all components (namely the driving component and the execution component) in the automatic driving unit 200 may be provided in the water tank. Alternatively, only the execution component may be provided in the water tank, while the driving component is provided outside the water tank. A specific structure can be provided according to an actual design. In order to reduce an overall footprint of the toilet, preferably, all components of the automatic driving unit 200 are provided in the water tank of the toilet.

Specifically, by integrating the automatic driving unit 200 onto the toilet, while functions of the original drain valve 100 can be kept, the valve trim 120 is driven automatically. This does not need manual operation and is convenient in use. Particularly, when installed on the drain valve 100, the automatic driving unit 200 is directly provided between the slider 130 and the valve trim 120, without changing other structures of the drain valve 100. After long-time use, even in case of a fault of a component, only the corresponding component is repaired or replaced without affecting other components. The drain valve 100 further keeps the original functions. Even in case of a fault of the automatic driving unit 200, the toilet also drains water normally. Therefore, when applied to the toilet, the automatic driving unit 200 with such a structure provided by the embodiment makes the toilet used more conveniently, and has a good stability in use and a low maintenance cost.

The present disclosure has been illustrated and described above with reference to the preferred implementations of the present disclosure, but those of ordinary skill in the art should understand that the above contents are further detailed descriptions on the present disclosure in conjunction with the specific implementations, and specific implementations of the present disclosure are not only limited to these descriptions. Without departing from the spirit and scope of the present disclosure, those skilled in the art can make various alterations in forms and details, including various simple deductions or replacements.

1. An automatic driving unit for a toilet drain valve, wherein the drain valve is provided in a water tank of a toilet, and comprises a valve casing, a valve trim, and a slider; the valve casing is provided with a water inlet located on a sidewall and communicating with the water tank, and a drain outlet located at one end; the valve trim is provided in the valve casing, and abuts against the drain outlet in an openable sealing manner; the slider is provided at the other end of the valve casing and is in transmission connection with the valve trim; and the automatic driving unit comprises a driving component, and an execution component provided in the valve casing;
the execution component comprises a fixed member and a movable member provided on the fixed member; the fixed member is fixed in the valve casing, and located between the valve trim and the slider; the movable member is movably provided on the fixed member along an axial direction of the valve casing relative to the fixed member; and the movable member is in transmission connection with the valve trim;
the driving component is provided outside the valve casing, is in transmission connection with the movable member and is configured to drive the movable member to move relative to the fixed member; and
the driving component is electrically connected to a sensing component on the toilet; and the sensing component is configured to acquire body information of a user, convert the body information into an electrical signal and transmit the electrical signal to the driving component.

2. The automatic driving unit for a toilet drain valve according to claim 1, wherein
the fixed member is provided with a housing; and the housing is nested in the valve casing and fixed on an inner wall of the valve casing; and
the movable member is a piston nested in the housing; and an end of the piston extends out of an end of the housing close to the valve trim and is fixedly connected to an end of the valve trim; or
the movable member is a piston nested in the housing; and an end of the piston extends out of an end of the housing away from the valve trim and is fixedly connected to an inner end of the slider.

3. The automatic driving unit for a toilet drain valve according to claim 2, wherein the driving component comprises a pressure adjustment component; the housing is a sealed housing and forms a sealed chamber inside; the piston comprises a piston body and a piston rod; and the piston body is slidably connected in the sealed chamber; and
when the end of the piston extends out of the end of the housing close to the valve trim and is fixedly connected to the end of the valve trim, a through hole is formed at the end of the housing close to the valve trim; the piston rod comprises one end fixedly connected to the piston body, and the other end fixedly connected to the valve trim via the through hole; an outer wall of the piston rod is hermetically connected with an inner wall of the through hole; and the pressure adjustment component communicates with the sealed chamber through a pressure pipeline penetrating through the valve casing and a sidewall of the housing; or
when the end of the piston extends out of the end of the housing away from the valve trim and is fixedly connected to the inner end of the slider, a through hole is formed at an end of the housing close to the slider; the piston rod comprises one end fixedly connected to the piston body, and the other end fixedly connected to the inner end of the slider via the through hole; an outer wall of the piston rod is hermetically connected with an inner wall of the through hole; and the pressure adjustment component communicates with the sealed chamber through a pressure pipeline penetrating through the valve casing and a sidewall of the housing.

4. The automatic driving unit for a toilet drain valve according to claim 3, wherein the pressure adjustment component comprises a hydraulic pump or an air pump.

5. The automatic driving unit for a toilet drain valve according to claim 2, wherein the fixed member further comprises an electromagnetic member provided in the housing; the movable member is a magnetic sensing member opposite to the electromagnetic member; and the driving component is a power supply; and
when the end of the piston extends out of the end of the housing close to the valve trim and is fixedly connected to the end of the valve trim, one of the electromagnetic member and the magnetic sensing member is fixedly connected in the housing, while the other one is movably provided in the housing, located between the electromagnetic member and the valve trim, and fixedly connected to the valve trim; or
when the end of the piston extends out of the end of the housing away from the valve trim and is fixedly connected to the inner end of the slider, one of the electromagnetic member and the magnetic sensing member is fixedly connected in the housing, while the other one is movably provided in the housing, located between the electromagnetic member and the slider, and fixedly connected to the slider.

6. The automatic driving unit for a toilet drain valve according to claim 5, wherein the housing is a sealed housing, and both the electromagnetic member and the magnetic sensing member are provided in the housing.

7. The automatic driving unit for a toilet drain valve according to claim 5, wherein the electromagnetic member is an electromagnet, and the magnetic sensing member is a permanent magnet or a metal member.

8. The automatic driving unit for a toilet drain valve according to claim 2, wherein the fixed member further comprises a gear provided in the housing; the movable member is a rack engaged with the gear and extending along the axial direction of the valve casing; the driving component is a motor; a guide seat is further provided on the inner wall of the valve casing; the rack is slidably connected to the guide seat; and the gear is fixedly connected to an output shaft of the motor; and
when the end of the piston extends out of the end of the housing close to the valve trim and is fixedly connected to the end of the valve trim, an end of the rack is fixedly connected to the valve trim; or
when the end of the piston extends out of the end of the housing away from the valve trim and is fixedly connected to the inner end of the slider, an end of the rack is fixedly connected to the slider.

9. The automatic driving unit for a toilet drain valve according to claim 1, wherein the sensing component comprises a capacitive sensor or a pressure sensor provided in a seat ring of a toilet seat, and the sensing component is configured to detect body information of the seat ring and generate a sensing signal.

10. The automatic driving unit for a toilet drain valve according to claim 9, further comprising an operating button, wherein the operating button is fixed on an outer wall of the toilet seat, and electrically connected to the driving component.

11. The automatic driving unit for a toilet drain valve according to claim 10, wherein the operating button comprises a base as well as a switch and a timing member that are arranged on the base; the switch is provided with an operating key outside the base; and the switch and the timing member are electrically connected to each other.

12. A drain valve assembly for a toilet, comprising a drain valve and the automatic driving unit for a toilet drain valve according to claim 1, wherein at least the execution component in the automatic driving unit is provided in the valve casing of the drain valve.
